(19) United States
(12) Patent Application Publication
(10) Pub. No.: US 2021/0285328 A1
(43) Pub. Date: Sep. 16, 2021

(54) AXIAL IMPELLER

(71) Applicant: Dyson Technology Limited, Wiltshire (GB)

(72) Inventors: Mahyar MAHMOODILARI, Bristol (GB); Vadivel Kumaran SIVASHANMUGAM, Swindon (GB); Lukasz Andrzej KOWALCZYK, Swindon (GB)

(73) Assignee: Dyson Technology Limited, Wiltshire (GB)

(21) Appl. No.: 17/257,800

(22) PCT Filed: May 17, 2019
(86) PCT No.: PCT/GB2019/051376

§ 371 Date: Jan. 4, 2021

(30) Foreign Application Priority Data
Jul. 5, 2018 (GB) 1811025.4

(51) Int. Cl. F01D 5/02; F04D 25/06; F01D 5/30; A45D 20/12

(52) U.S. Cl. CPC F01D 5/021; F04D 25/06; F01D 5/30; F05D 2240/307; F05D 2240/301; F05D 2240/304; A45D 20/12

(57) ABSTRACT

An axial impeller has a hub and a plurality of blades extending about the hub. Each blade has a root fixed to the hub, a tip spaced away from the hub, a leading edge extending between the root and the tip, and a trailing edge extending between the root and the tip. The root is inclined at a first angle α relative to a first axis B parallel to a rotational axis of the impeller, the tip is inclined at a second angle β relative to the first axis B, and the second angle β is greater than the first angle α. A first end of the trailing edge at the root is located downstream of a second end of the trailing edge at the tip, and a first end of the leading edge at the root is downstream of a second end of the leading edge at the tip.

### CROSS REFERENCE TO RELATED APPLICATION

This application is a national phase application under 35 USC 371 of International Application No. PCT/GB2019/051376, filed May 17, 2019, which claims the priority of United Kingdom Application No. 1811025.4, filed Jul. 5, 2018, the entire contents of each of which are incorporated herein by reference.

### FIELD OF THE DISCLOSURE

The present invention relates to an axial impeller, and more particularly, although not exclusively, to an axial impeller for an electric motor.

### BACKGROUND OF THE DISCLOSURE

Electric motors are commonly used to generate airflow through numerous household appliances, including, for example, hair care appliances such as hair dryers.

There is a general desire to improve electric motors in a number of ways, including, for example, size, weight, manufacturing cost, efficiency, reliability, and noise. Improvements to electric motors can lead to corresponding improvements for the appliance in which the electric motor is contained.

### SUMMARY OF THE DISCLOSURE

According to a first aspect of the present invention there is provided an axial impeller comprising a hub and a plurality of blades extending about the hub, each blade comprising a root fixed to the hub, a tip spaced away from the hub, a leading edge extending between the root and the tip, and a trailing edge extending between the root and the tip, wherein the root is inclined at a first angle relative to a first axis parallel to a rotational axis of the impeller, the tip is inclined at a second angle relative to the first axis, the second angle being greater than the first angle, and a first end of the trailing edge at the root is located downstream of a second end of the trailing edge at the tip, and a first end of the leading edge at the root is downstream of a second end of the leading edge at the tip.

The axial impeller according to the first aspect of the present invention may be advantageous principally as the root is inclined at a first angle relative to a first axis parallel to a rotational axis of the impeller, the tip is inclined at a second angle relative to the first axis, the second angle is greater than the first angle, and a first end of the trailing edge at the root is located downstream of a second end of the trailing edge at the tip, and a first end of the leading edge at the root is downstream of a second end of the leading edge at the tip.

In particular, the inventors of the present application have found that an axial impeller having the blade geometry described above may offer improved flow characteristics. For example, an axial impeller as described above may be capable of providing a desired flow rate at a lower speed of rotation relative to known axial impellers and/or delivering the same duty as known axial impellers at a lower speed of rotation. This may provide, for example, acoustic benefits, as an impeller running at a lower speed may generate less noise than an impeller running at a higher speed.

It will be appreciated that each of the plurality of blades may comprise the same geometry, and references below to “a blade” or “the blade” may be interpreted as meaning any one of the plurality of blades.

A rate of transition between the first and second angles may be irregular between the root and the tip, for example in a radial direction between the root and the tip. A rate of transition between the first and second angles may increase in a radial direction between the root and the tip.

The first angle may increase by 2-10% between the root and a mid-point between the root and the tip, for example by between 3-6%. The angle of inclination may increase by 25-35% of the value of the first angle between the mid-point and the tip, for example by between 28-32%. The second angle may be in the region of 25-50% larger than the first angle, for example in the region of 30-40% larger than the first angle.

The first angle may be in the range of 45-55°, in the range of 47-53°, or in the range of 48-50°. The second angle may be in the range of 60-70°, in the range of 63-67°, or in the range of 65-66°. The angle of inclination of the blade at the mid-point between the root and the tip may be in the range of 45-55°, in the range of 49-52°, or in the range of 50-51°.

The first and second angles may comprise blade inlet angles.

The first and second angles may comprise angles enclosed by a line extending between the leading and trailing edges, for example a camber line of the blade at the leading edge, and a line parallel to a rotational axis of the impeller, for example a line parallel to a central longitudinal axis of the impeller. The first and second angles may be measured in a direction opposite to the direction of airflow through the impeller.

The trailing edge may comprise a curved profile in a meridional plane established by an axial direction and a radial direction and/or the leading edge may comprise a curved profile in the meridional plane. The curvature of the trailing edge in the meridional plane may be greater than the curvature of the leading edge in the meridional plane.

The trailing edge may comprise a convex profile in the meridional plane, and/or the leading edge may comprise a concave profile in the meridional plane.

The trailing edge may comprise a curved profile when viewed in a direction parallel to a rotational axis of the impeller and/or the leading edge may comprise a curved profile when viewed in a direction parallel to a rotational axis of the impeller. The curvature of the trailing edge may be greater than the curvature of the leading edge when viewed in a direction parallel to a rotational axis of the impeller. The trailing edge may comprise a concave profile when viewed in a direction parallel to a rotational axis of the impeller and/or the leading edge may comprise a concave profile when viewed in a direction parallel to a rotational axis of the impeller. The trailing edge may comprise a more concave profile than the leading edge when viewed in a direction parallel to a rotational axis of the impeller.

A cross-sectional shape of the blade at the root may be different to a cross-sectional shape of the blade at the tip. A camber line of the blade at the root may be different to a camber line of the blade at the tip, for example increased or decreased in length and/or increased or decreased in curvature.

A chord length of the blade at the tip may be different to a chord length of the blade at the root. A chord length of the blade at the tip may be greater than the chord length of the blade at the root.

The chord length of the blade at the tip may be greater than the chord length of the blade at the root by between 10-80%, by between 20-70%, by between 30-60%, or by between 40-50%, of the chord length of the blade at the root. The chord length of the blade at the root may be in the range of 4-7 mm, or in the range of 5-6 mm. The chord length of the blade at the tip may be in the range of 6-10 mm, or in the range of 7-9 mm.

The chord length of the blade at a mid-point between the root and the tip may be greater than the chord length of the blade at the root by between 5-25%, or by between 10-20%. The chord length at the mid-point between the root and the tip may be in the range of 4-8 mm, or in the range of 5-7 mm.

A maximum thickness of the blade may vary between the root and the tip. For example, the blade may be thicker at the root than at the tip. The maximum thickness of the blade at the tip may be between 30-70%, or between 40-60%, of the maximum thickness of the blade at the root. The maximum thickness of the blade at the tip may be around 50% of the maximum thickness of the blade at the root. The maximum thickness of the blade at the root may be in the range of 0.8-1.2 mm, or in the range of 0.9-1.1 mm. The maximum thickness of the blade at the root may be around 1 mm. The maximum thickness of the blade at the tip may be in the range of 0.3-0.7 mm, or in the range of 0.4-0.6 mm. The maximum thickness of the blade at the tip may be around 0.5 mm.

The maximum thickness of the blade at a mid-point between the root and the tip may be between 60-80%, or between 65-70%, of the maximum thickness of the blade at the root. The maximum thickness of the blade at the mid-point may be in the range of 0.5-0.8 mm, or in the range of 0.6-0.7 mm.

A distance between the first and second ends of the trailing edge in an axial direction, for example a direction parallel to a rotational axis of the impeller viewed in the meridional plane, may be greater than a distance between first and second ends of the leading edge in the axial direction. The trailing edge may be longer than the leading edge.

At least a portion of a suction surface of each blade may be curved in a direction opposite to a direction of airflow through the impeller. At least a portion of each blade may be forward swept. For example, each blade may be forward swept in the region of the tip at the leading and/or trailing edge.

The impeller may comprise 13 blades. The hub may comprise a metallic material, for example brass, and the blades may comprise a plastic material. The use of plastic material for the blades may be beneficial as plastic material may allow for more complex blade geometries as used in the present invention. The blades may be overmoulded to the hub, for example as part of an injection moulding process. Each of the plurality of blades may overlap an adjacent one of the plurality of blades, for example overlap in a circumferential direction. There may be no gaps between adjacent blades, for example when viewed along a direction through which air flows through the impeller in use.

According to a second aspect of the present invention there is provided an electric motor comprising the axial impeller of the first aspect of the present invention.

The electric motor may comprise a rotor assembly comprising a shaft to which the axial impeller is attached, a rotor core permanent magnet, and a bearing assembly. The electric motor may comprise a stator core assembly for causing rotation of the impeller.

According to a third aspect of the present invention there is provided a hair care appliance comprising the electric motor of the second aspect of the present invention. The hair care appliance may, for example, comprise a hairdryer or a hot styling brush.

Preferential features of aspects of the present invention may be equally applied to other aspects of the present invention, where appropriate.

### BRIEF DESCRIPTION OF THE FIGURES

In order to better understand the present invention, and to show more clearly how the invention may be put into effect, the invention will now be described, by way of example, with reference to the following drawings:

FIG. 1 is a front perspective view of an axial impeller according to the present invention;

FIG. 2 is a front view of the axial impeller of FIG. 1;

FIG. 3 is a rear view of the axial impeller of FIG. 1;

FIG. 4 is a rear perspective view of the axial impeller of FIG. 1;

FIG. 5 is a side view of the axial impeller of FIG. 1;

FIG. 6 is a schematic side view illustrating angles of inclination of blades of the axial impeller of FIG. 1;

FIG. 7 is a schematic projection of a front view of the blade of FIG. 6 into a plane orthogonal to a rotational axis of the impeller of FIG. 1;

FIG. 8 is a schematic projection of the blade of FIG. 6 in the meridional plane;

FIG. 9a is a schematic cross-sectional view of a blade of the impeller of FIG. 1 at the tip of the blade;

FIG. 9b is a schematic cross-sectional view of a blade of the impeller of FIG. 1 at a radial mid-point of the blade;

FIG. 9c is a schematic cross-sectional view of a blade of the impeller of FIG. 1 at the root of the blade;

FIG. 10 is a front perspective view of a known prior art impeller;

FIG. 11 is a plot of flow rate vs speed comparing the impeller of FIG. 1 vs the impeller of FIG. 10;

FIG. 12 is an exploded perspective view of an electric motor comprising the impeller of FIG. 1; and

FIG. 13 is a schematic view of a hairdryer comprising the electric motor of FIG. 12.

### DETAILED DESCRIPTION OF THE DISCLOSURE

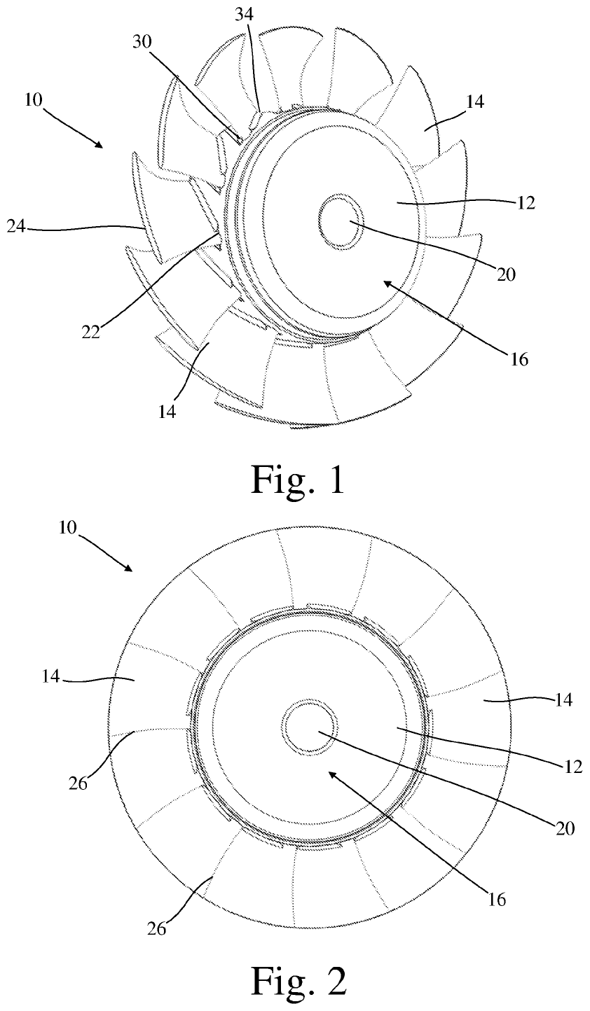

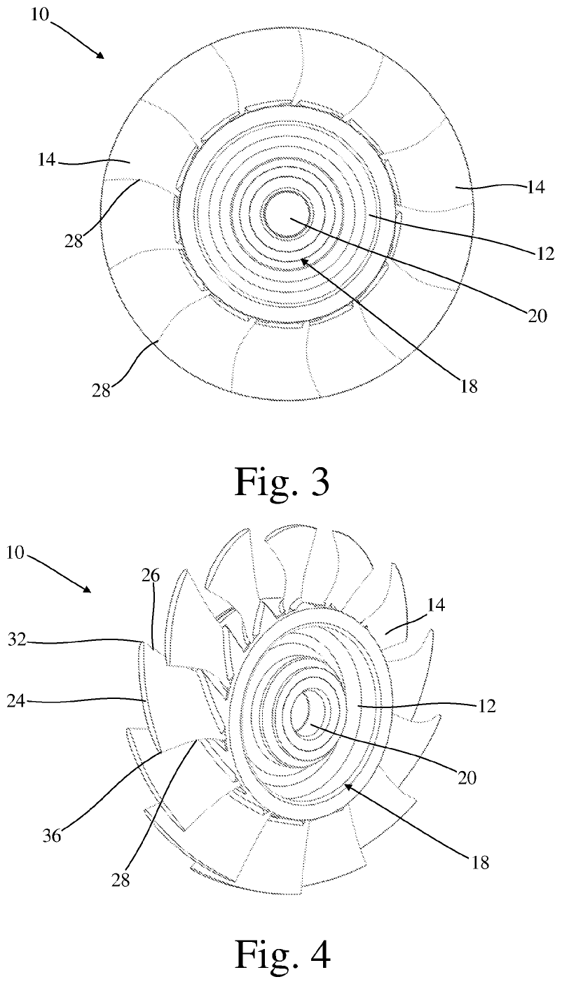

An axial impeller according to a first aspect of the present invention, generally designated 10, is shown in FIGS. 1 to 5.

The axial impeller 10 comprises a hub 12, and a plurality of blades 14 extending circumferentially about the hub 12.

The hub 12 is substantially cylindrical in form, having a closed upstream end 16 and an open downstream end 18. The hub 12 comprises a central bore 20 which is shaped and dimensioned to receive a shaft 106 of a rotor assembly 102 of an electric motor 100, for example with an interference fit or with sufficient clearance to enable an adhesive fixing. The hub 12 is formed of a metallic material, and in a presently preferred embodiment is formed of brass.

As mentioned above, the plurality of blades 14 extend circumferentially about the hub 12, with the blades 14 being spaced equidistantly about the circumference of the hub 12. In a presently preferred embodiment there are 13 blades 14 which extend about the hub 12. The blades 14 are formed of a plastic material, and are overmoulded to the hub 12, for example as part of an injection moulding process.

The geometry of each of the plurality of blades 14 is the same, and hence only a single blade 14 will be described below for the sake of brevity.

Each blade 14 has a root 22, a tip 24, a leading edge 26, and a trailing edge 28. The root 22 is a radially innermost edge of the blade 14 which is closest to and attached to the hub 12. The tip 24 is a radially outermost edge of the blade 14, spaced apart from the hub 12. The leading edge 26 is a forwardmost edge in a direction of airflow through the impeller 10, for example an edge of the blade 14 which air contacts first as the impeller 10 rotates in use, and extends between the root 22 and the tip 24. The trailing edge 28 is a rearmost edge in a direction of airflow through the impeller 12, for example an edge of the blade 14 which contacts air last as the impeller 10 rotates in use, and extends between the root 22 and the tip 24.

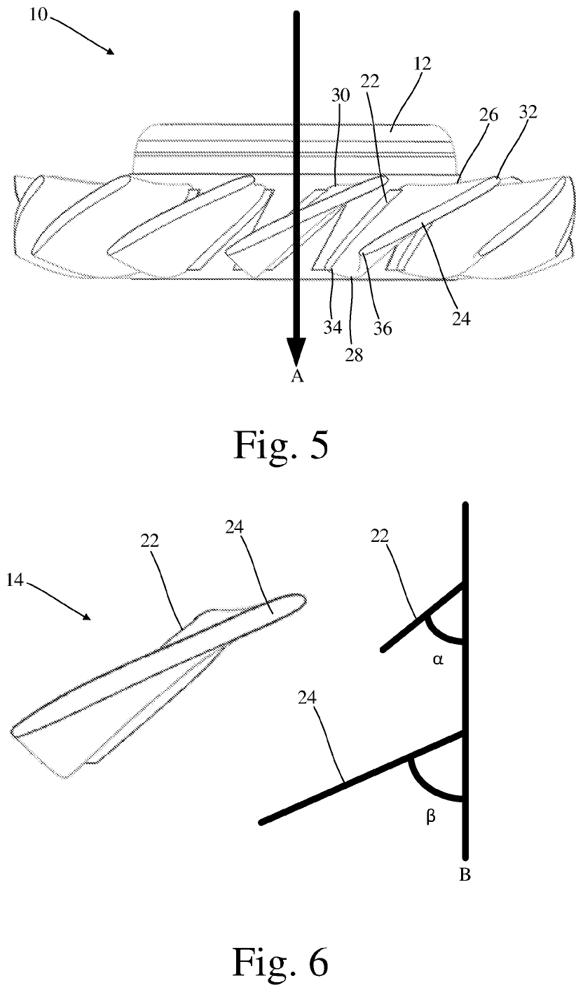

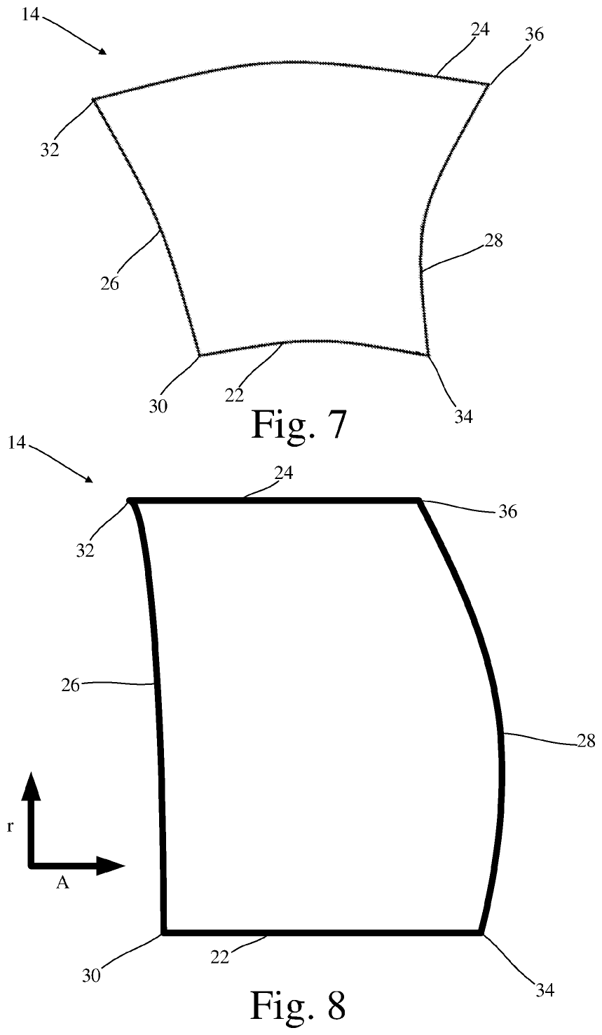

A first end 30 of the leading edge 26 at the root 22 is attached to the hub 12, whilst a second end 32 of the leading edge 26 at the tip 24 is spaced from the hub 12. The second end 32 of the leading edge 26 is located upstream of the first end 30 of the leading edge 26, for example upstream in a direction of airflow, denoted by arrow A in FIG. 5, through the impeller 10 in use. This gives the leading edge 26 a curved, in this instance concave, profile when the blade 14 is viewed in a meridional plane defined by an axis extending parallel to a rotational axis of the impeller 10 and a radial axis, as seen in FIG. 8. The leading edge 26 also has a curved, in this instance concave, profile when viewed along an axis of rotation of the impeller 10 in a direction of airflow through the impeller 10 in use, as seen in FIG. 7

A first end 34 of the trailing edge 28 at the root 22 is attached to the hub 12, whilst a second end 36 of the trailing edge 28 at the tip 24 is spaced from the hub 12. The second end 36 of the trailing edge 28 is located upstream of the first end 34 of the trailing edge 28, for example upstream in a direction of airflow, denoted by arrow A in FIG. 5, through the impeller 10 in use. This gives the trailing edge 28 a curved, in this instance convex, profile when the blade 14 is viewed in a meridional plane defined by an axis extending parallel to a rotational axis of the impeller 10 and a radial axis, as seen in FIG. 8. It can also be seen from FIG. 8 that the trailing edge 28 has a greater curvature than the leading edge 26 in the meridional plane. The leading edge 26 also has a curved, in this instance concave, profile when viewed along an axis of rotation of the impeller 10 in a direction of airflow through the impeller 10 in use, as seen in FIG. 7. It can also be seen from FIG. 7 that the trailing edge 28 has a greater curvature than the leading edge 26 when viewed along an axis of rotation of the impeller 10 in a direction of airflow through the impeller 10, ie that the trailing edge 28 is more concave than the leading edge 26 when viewed along an axis of rotation of the impeller 10 in a direction of airflow through the impeller 10. As the second ends 32,36 of the leading 26 and trailing 28 edges respectively are located at the same radial distance from the hub, the trailing edge 28 has a greater distance than the leading edge 26 in light of its greater curvature.

In the manner described above, the second end 32 of the leading edge 26 at the tip 24 and the second end 36 of the trailing edge 28 at the tip 24 are forward swept, for example swept in a direction opposite to the direction of airflow through the impeller 10 in use. This means that at least a portion of a suction surface of each blade 14 is forward swept.

As mentioned above, the root 22 of each blade 14 is attached to the hub 12, whilst the tip 24 of each blade 14 is spaced away from the hub 12. The root 22 is inclined relative to an axis, indicated B in FIG. 6, parallel to a rotational axis of the impeller 10, by a first angle α. In a presently preferred embodiment the first angle α is 48.48°. The tip 24 is also inclined relative to axis B by a second angle β. In a presently preferred embodiment the second angle β is 65.41°. Thus it can be seen that the tip 24 has a greater angle of inclination than the root 22, as depicted in FIG. 6.

In a presently preferred embodiment, an intermediate angle of inclination γ of the blade 14 at a radial mid-point between the root 22 and the tip 24 is 50.81°. Thus it can be seen that the transition from the first angle α to the second angle β is irregular. In particular, the rate of transition from the first angle α to the intermediate angle γ is lower than the rate of transition from the intermediate angle γ to the second angle β.

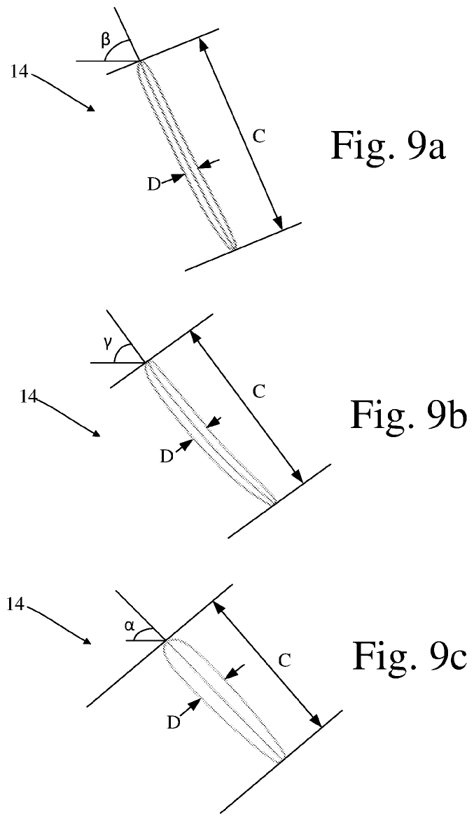

Other properties of the blade 14 also vary in a radial direction between the root 22 and the tip 24, as can be seen from FIGS. 9a to 9c. In particular, the blade 14 has a cross-sectional shape that varies between the root 22 and the tip 24.

The blade 14 has a chord length C of around 5.53 mm at the root 22 (as seen in FIG. 9c), a chord length C of around 6.33 mm at a mid-point between the root 22 and the tip 24 (as seen in FIG. 9b), and a chord length C of around 8.08 mm at the tip 24 (as seen in FIG. 9a). Thus the chord length C of the blade 14 is larger at the tip 24 than the root, and in particular in the presently preferred embodiment the chord length C at the tip 24 is 1.461 times the chord length at the root 22.

The blade 14 has a maximum thickness D of around 0.99 mm at the root 22 (as seen in FIG. 9c), a maximum thickness D of around 0.66 mm at a mid-point between the root 22 and the tip 24 (as seen in FIG. 9b), and a maximum thickness D of around 0.52 mm at the tip 24 (as seen in FIG. 9a). Thus the maximum thickness D of the blade 14 is smaller at the tip 24 than at the root 22, and in particular in the presently preferred embodiment the maximum thickness D of the blade 14 at the tip 24 is 0.525 times the maximum thickness D of the blade 14 at the root 22.

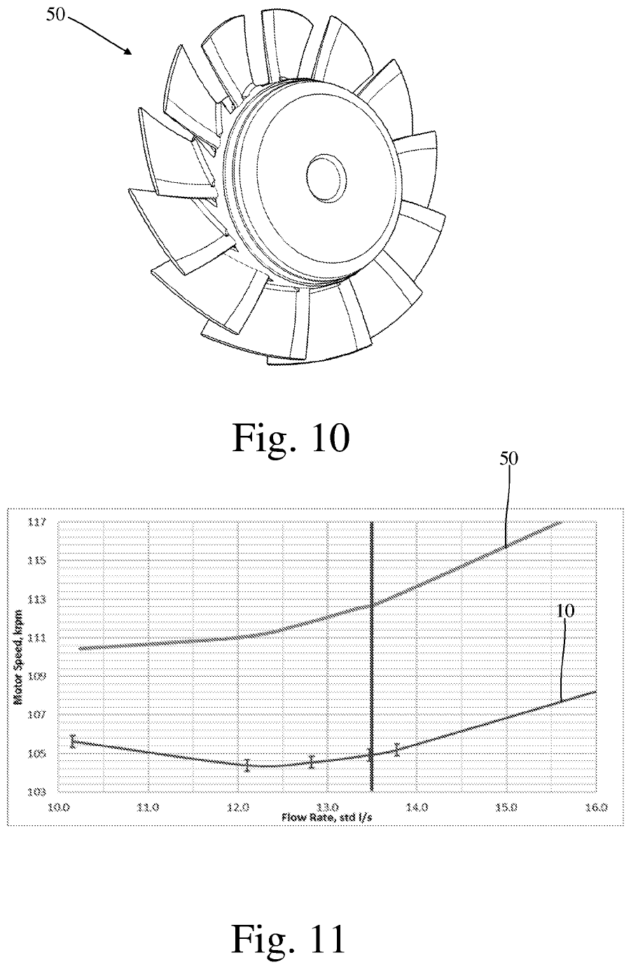

It has been found by the inventors of the present application that an impeller 10 having blades 14 with the characteristics provided above can provide advantages relative to known impellers. For example, a plot of the performance of the impeller 10 of the present invention relative to a known impeller 50, the impeller disclosed in published UK patent application GB2557958 and herein reproduced in FIG. 10, is shown in FIG. 11.

It is clear from FIG. 11 that the impeller 10 can provide the same flow rate as the known impeller 50 whilst rotating at a lower speed. This may provide the impeller 10 with improved operating characteristics, including, for example improved acoustic characteristics and/or a reduction in the level of power needed to operate the impeller 10 to provide a desired flow rate.

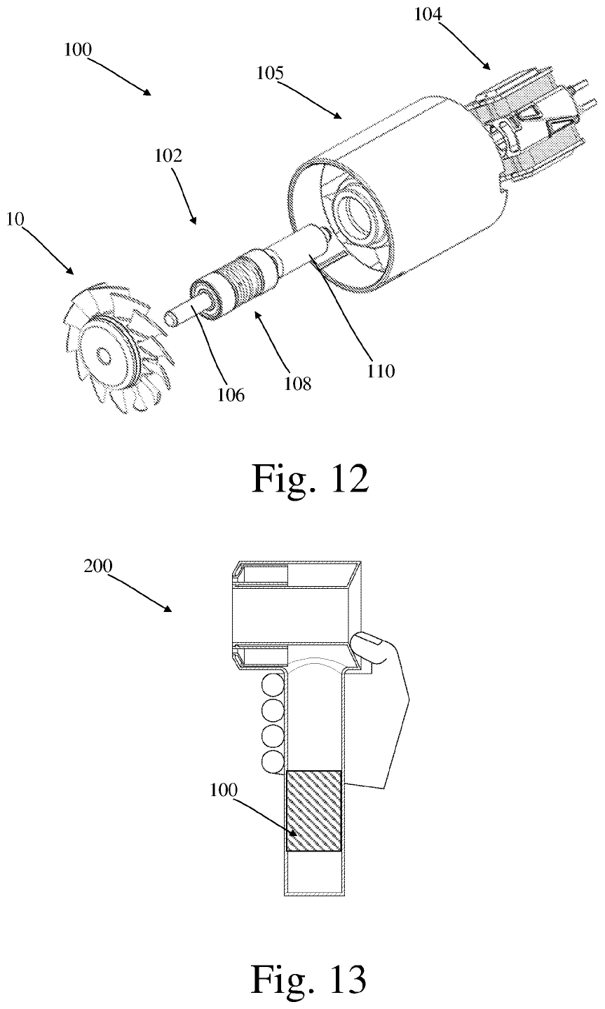

An electric motor 100 comprising the impeller 10 is shown in FIG. 12. The electric motor 100 comprises the impeller 10, a rotor assembly 102 (of which the impeller 10 may form a part), a stator assembly 104, and a frame 105. The rotor assembly 102 comprises a shaft 106 to which the impeller 10 is attached, a bearing assembly 108, and a rotor core permanent magnet 110. The electric motor 100 generally has the form of the electric motor described in published PCT patent application WO2017/098200, and so further details of the electric motor 100 will not be reproduced here for brevity.

A schematic view of a hair care appliance 200 comprising the electric motor 100 is shown in FIG. 13 in the form of a hairdryer.

1. An axial impeller comprising a hub and a plurality of blades extending about the hub, each blade comprising a root fixed to the hub, a tip spaced away from the hub, a leading edge extending between the root and the tip, and a trailing edge extending between the root and the tip, wherein the root is inclined at a first angle relative to a first axis parallel to a rotational axis of the impeller, the tip is inclined at a second angle relative to the first axis, the second angle being greater than the first angle, and a first end of the trailing edge at the root is located downstream of a second end of the trailing edge at the tip, and a first end of the leading edge at the root is downstream of a second end of the leading edge at the tip.

2. The axial impeller of claim 1, wherein a rate of transition between the first and second angles is irregular between the root and the tip.

3. The axial impeller of claim 1, wherein the second angle is in the region of 25-50% larger than the first angle.

4. The axial impeller of claim 1, wherein the trailing edge comprises a curved profile in a meridional plane established by an axial direction and a radial direction and the leading edge comprises a curved profile in the meridional plane.

5. The axial impeller of claim 4, wherein the curvature of the trailing edge in the meridional plane is greater than the curvature of the leading edge in the meridional plane.

6. The axial impeller of claim 1, wherein a cross-sectional shape of the blades at the root is different to a cross-sectional shape of the blades at the tip.

7. The axial impeller of claim 1, wherein a chord length of the blades at the tip is greater than the chord length of the blades at the root.

8. The axial impeller of claim 7, wherein the chord length of the blades at the tip is greater than the chord length of the blades at the root by between 10-80%.

9. The axial impeller of claim 1, wherein a maximum thickness of the blades is greater at the root than at the tip.

10. The axial impeller of claim 9, wherein the maximum thickness of the blades at the tip is between 30-70% of the maximum thickness of the blades at the root.

11. An electric motor comprising an impeller according to claim 1.

12. A haircare appliance comprising an electric motor as claimed in claim 11.
